(19) United States
(12) Patent Application Publication
(10) Pub. No.: US 2008/0312370 A1
(43) Pub. Date: Dec. 18, 2008

(54) Use of a Precipitated Silica for Increasing the Impact-Resistance of a Thermoplastic Polymeric Material

(75) Inventors: Antoine Guiu, Paris (FR); Yves Bomal, Perret (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, Aubervilliers Cedex (FR)

(21) Appl. No.: 11/794,349

(22) PCT Filed: Dec. 27, 2005
(86) PCT No.: PCT/FR2005/003291

§ 371 Date: Apr. 10, 2008

(30) Foreign Application Priority Data
Dec. 30, 2004 (FR) 0414102

(51) Int. Cl. C08K 3/36

(52) U.S. Cl. 524/493

(57) ABSTRACT

The invention relates to a method for employing, in a thermoplastic polymer, a silica having a BET surface less than or equal to 130 m²/g for increasing the impact resistance of a material. The silica employed can be obtained by drying a silica aqueous dispersion produced from a reaction of a silicate and of an acidulant, comprising the following steps: forming a starter containing at least a portion of the total quantity of the silicate and an electrolyte; (B) adding an acidulant to the starter of step (A) until a pH value ranging from 7 to 8.5 is obtained, and; (C) if necessary, adding the remaining quantity of silicate to the reaction medium obtained from step (B), in conjunction with another portion of the acidulant. The invention also relates to the thermoplastic polymeric materials, particularly based on polyolefins that are obtained within this scope.

The present invention relates to the reinforcement of polymeric materials. More specifically, it concerns the improvement of the impact resistance of thermoplastic material.

The term “impact resistance” (or “impact strength”) of a polymeric material, as used in the present description, denotes the greater or lesser capacity of a polymeric material to resist breakage under the effect of an impact, in particular under the effect of an impact at high speed, at a given temperature. Thus, materials having good impact resistance are generally said to be “tough” as opposed to “fragile” materials which break easily under the effect of an impact.

More specifically, the impact resistance of a polymeric material at a given temperature may be quantified using the so-called impact test methods. This type of test generally consists in cutting a sample consisting of the material to be tested (U-shaped or, more often, V-shaped cut), then in smashing this cut sample under the impact of a weight (pendulum or hammer) and in measuring the energy absorbed through the breaking of the sample; this reflects the breakage resistance energy (or “resilience”) of the material. The more energy there is absorbed, the greater the impact resistance of the material.

Thus, the impact resistance of a polymer can easily be measured by using the so-called “Charpy impact test” method, wherein the energy used up to break the sample is measured by releasing a pendulum from a given height and by establishing the difference between the height from which the pendulum falls and that to which it rises once the bar has been broken; the less the amount of energy used up to break the material, the higher the pendulum rises. In this regard, the impact resistance of a polymeric material can be determined using the specific method of Standard ISO 179 which consists in dropping a hammer onto a sample which has dimensions of 80 mm×10 mm×4 mm and is cut along its centre while resting on two supports positioned at its ends.

Good impact resistance qualities are required in a large number of applications of thermoplastic polymers. Thus, it is especially desirable for thermoplastic polymeric materials used for forming containers to have sufficient qualities in terms of toughness to ensure that the container does not break in the event of impact. More generally, if thermoplastic polymers are used to form elements liable to be subjected to repeated impacts, for example coating layers, mechanical parts, car parts, it is desirable for the polymer used to be as sturdy as possible, so these elements have a satisfactory service life.

A known solution for improving the impact resistance properties of a thermoplastic material consists in introducing an elastomer within the material as a polymeric filler. In this regard, U.S. Pat. No. 4,229,504 describes, for example, the use of an elastomer in a polyolefin such as polypropylene.

In the case of polypropylene-type thermoplastic materials, another way to bolster the impact resistance properties is to add to the materials a polyethylene or α-olefin phase-type polymeric filler having a very low molecular weight, optionally in conjunction with an elastomeric phase, as proposed in U.S. Pat. No. 5,925,703 or U.S. Pat. No. 5,041,491. There have also been proposed in this regard more specific polymeric fillers such as the mixtures of ethylene/propylene copolymers and ethylene/α-olefin copolymers described in U.S. Pat. No. 6,391,977.

Another solution proposed to increase the resilience of thermoplastic polymeric materials such as polypropylene consists in incorporating therein calcium carbonate particles which have been surface-treated with stearic acid. Reference may be made in this regard, in particular, to the article by Zuiderduin et al. in Polymer, Volume 44, pages 261 to 275 (2003), or else to application WO 00/049,081 which describes in more general terms the use of inorganic fillers treated with a fatty acid for this type of application.

An object of the present invention is to provide a means for improving the impact strength of thermoplastic materials, in particular that of thermoplastic materials based on polyolefins such as polypropylene, without having necessarily to modify the composition of the polymer by adding the aforementioned specific polymeric fillers or to use inorganic fillers treated with a fatty acid.

To this end, the present invention provides the use, in a thermoplastic polymeric material, of a specific precipitated silica as an inorganic filler for increasing the impact resistance of said polymeric material.

More specifically, the silica useful in accordance with the invention is a silica which:

(i) has a BET less than or equal to 130 m²/g; and

(ii) is obtainable by a specific process, namely by drying (preferably by spray drying) an aqueous silica dispersion produced from a process for the precipitation of silica by reacting a silicate and an acidifying agent, wherein the precipitation process includes the following steps:
(A) forming a starter containing in aqueous medium:
   at least a portion of the total amount of silicate involved in the precipitation reaction; and
   an electrolyte;
(B) adding a first portion of acidifying agent to the starter from step (A) until a pH of between 7 and 8.5 is obtained; and
(C) if necessary, adding to the reaction medium obtained from step (B) the remaining amount of silicate in conjunction with another portion of the acidifying agent, the pH then being preferably maintained at a substantially constant value, advantageously at a pH of between 7 and 8.5, throughout the joint addition.

The silicate and the acidifying agent used in the aforementioned steps (A) to (C) may be selected from the silicates and acidifying agents conventionally used in processes for the precipitation of silica from silicate in an acid medium. Thus the silicate may be any common form of silicate, in particular metasilicates or disilicates. Advantageously, the silicate from step (A) and from optional step (C) is an alkali metal silicate, preferably a potassium silicate or more advantageously a sodium silicate. According to a beneficial embodiment, the silicate is a sodium silicate having an SiO₂/Na₂O ratio by weight of between 3 and 4, typically between 3.3 and 3.6, for example approximately 3.4 to 3.5.

Besides, the acidifying agent used in steps (A) to (C) may advantageously be, in particular, a strong acid such as sulphuric acid, hydrochloric acid or nitric acid or else an organic acid such as acetic acid, formic acid or carbonic acid. Advantageously, the acidifying agent used is sulphuric acid, especially if the silicate used is sodium silicate.

The starter formed in step (A) comprises all or a portion of the silicate and an electrolyte, generally dissolved in water.

The term “electrolyte”, as used in the present document, is to be understood in its usual sense and denotes any substance or compound which breaks down or is decomposed in aqueous solution to form ionic species or charged particles. Preferably, the electrolyte of the starter from step (A) is an alkaline or alkaline earth salt, preferably a salt of the metal of the silicate used. Advantageously, the electrolyte is sodium sulphate if the silicate is sodium silicate and the acidifying agent is sulphuric acid.

If the electrolyte is an alkali metal salt, its concentration is advantageously between 0.05 and 0.7 mol/L in the starter, especially if the electrolyte is sodium sulphate. If the electrolyte used is an alkaline earth metal salt, its concentration in the starter is preferably between 0.001 and 0.01 mol/L.

The aforementioned steps (A) to (C) are advantageously carried out at a temperature of from 60 to 95° C., typically between 80 and 95° C., for example at a temperature of approximately 90 to 95° C.

The silica useful according to the invention is preferably a precipitated silica obtained by drying, preferably by spray drying, an aqueous silica dispersion produced from a process including the aforementioned steps (A) to (C), preferably an aqueous silica dispersion having a dry matter content of at least 18%, especially at least 20% and typically at least 25%. Alternatively, the silica may be a silica prepared using another process but having the same characteristics; it is, in any case, generally a precipitated silica.

The inventors have now evidenced that the incorporation of a silica of the aforementioned type into a thermoplastic polymeric material significantly improves the impact resistance of the material without having to modify the surface of the silica, for example using fatty acids. The inventors have especially observed this phenomenon for materials based on polyolefins such as polypropylene.

These results are highly surprising insofar as it is generally known that the incorporation of an inorganic filler into a polymeric material tends to reduce impact resistance if the filler is not surface-treated with a fatty acid-type organic agent, especially if this polymer is a polyolefin of the polypropylene type. Such an effect is generally attributed to the formation of flaws in the material due, in particular, to the creation of organic/inorganic interfaces. However, it has now been found that, wholly unexpectedly, the silicas evidenced by the inventors lead, conversely, to an improvement in impact resistance when used as inorganic fillers in a thermoplastic polymeric material.

Moreover, the work carried out by the inventors has also evidenced that, in conjunction with the increase in impact resistance, the incorporation of the aforementioned silicas into a thermoplastic polymeric material leads, in most cases, to an unexpected improvement in the tensile elongation characteristics of the material. Especially, the use of the silicas of the aforementioned type as an inorganic filler in a thermoplastic polymeric material usually increases the tensile elongation at break of the material as measured to Standard ISO 527; this can prove advantageous, especially if the material is intended to be subjected to high degrees of bending, for example if it is used in injected parts having complex shapes or else if it is intended to act as a hinge between two parts.

Furthermore, it has been found that the incorporation of the aforementioned silicas into a thermoplastic polymeric material does not reduce the rigidity of the material. Indeed, in several cases, the rigidity of the material even increases, resulting in an increase in the flexural modulus of the material (as measured to Standard ISO 178). In other words, the silicas used therefore allow both impact resistance and rigidity to be increased. The possibility of such combined improvement of these two characteristics as a result of the use of a single filler in a polymer, especially of the polyolefin type, is highly surprising: usually, the introduction of a silica-type inorganic filler into a polymeric material generally leads to selective improvement either in impact resistance or in the rigidity of the material, and the improvement in one of these properties generally has an adverse effect on the other, usually necessitating the use of a mixture of fillers of differing types if it is desirable to obtain a combined increase in the two properties.

In particular, in order to obtain the aforementioned effects in a particularly pronounced manner, it usually proves advantageous for the silica used in accordance with the invention to be a silica obtainable (and preferably obtained) by drying, preferably by spray drying, an aqueous silica dispersion produced from a process for the precipitation of silica by reacting a silicate and an acidifying agent, wherein the precipitation process includes the following steps:
(A) forming a starter containing in aqueous medium:
   a portion only of the total amount of silicate involved in the reaction; and
   an electrolyte, preferably of the aforementioned type;
(B) adding a first portion of acidifying agent to the starter from step (A) until a pH of between 7 and 8.5, preferably between 7.5 and 8.5 is obtained;
(C) adding to the reaction medium obtained from step (B) the second portion of the silicate, while jointly introducing another portion of the acidifying agent, while maintaining the pH of the medium substantially constant during this joint addition, preferably at about a value of between 7 and 8.5, advantageously between 7.5 and 8.5, for example while maintaining the pH at a value substantially equal to the pH achieved in step (B).

Whatever the embodiment of steps (A), (B) and (C), a silica which may be used in accordance with the invention is advantageously obtained by filtering the suspension, for example over a filter press (where the filter cake can advantageously be washed, for example with water, in particular to eliminate excessive reagents), then by mechanically disintegrating the filter cake obtained (which is generally viscous and non-pumpable), advantageously by adding thereto a chemical disintegrating agent such as sodium aluminate and by spray drying the cleaved cake obtained, for example using a liquid-pressure or two-fluid nozzle sprayer.

According to an embodiment of interest, the silica used in accordance with the invention is a silica in the form of substantially spherical balls, which is obtainable (and preferably obtained) by spray drying an aqueous silica dispersion, wherein said aqueous silica dispersion:
is produced from a process for the precipitation of silica by reacting a silicate and an acidifying agent, including the successive steps (A) to (C) as defined hereinbefore, for example under the foregoing preferential conditions,
has a dry matter content of at least 18% by mass, for example at least 20% by mass and more specifically at least 25% by mass; and
has a pH of at least 4, preferably at least 4.5, for example between 5 and 7.

In this regard, the silica used may, for example, be a silica of the type of that described in application EP 396 450.

According to a particularly beneficial embodiment, the used silica is obtainable (and preferably obtained) by carrying out the following steps:
(A) forming a starter containing in aqueous medium:
   a silicate, preferably sodium silicate; and
   an electrolyte, preferably sodium sulphate;
(B) adding an acidifying agent, preferably sulphuric acid, to the starter from step (A) until a pH of between 7.5 and 8.5, for example between 7.8 and 8.2, typically a value of approximately 8 is obtained;
(C) adding a silicate to the reaction medium obtained from step (B), preferably sodium silicate, while jointly introducing an acidifying agent, preferably sulphuric acid, while maintaining the pH of the medium substantially constant in the pH range of between 7.5 and 8.5, for example between 7.8 and 8.2 and typically at a value of 8+/−0.1, during this joint addition;
(D) adding an acidifying agent, preferably sulphuric acid, to the reaction medium obtained from step (C) until a pH of between 4 and 7, typically between 4.5 and 6 is obtained;
(E) filtering the dispersion obtained from step (D), then mechanically disintegrating the filter cake obtained, preferably in the presence of sodium aluminate as the cleaving agent; and
(F) spray drying the disintegrated cake obtained from step (E).

Whatever the exact manner by which it is prepared, a silica used in accordance with the invention has a BET specific surface area less than or equal to 130 m²/g. The term “BET specific surface area”, as used in the present description, refers to the specific surface area of the silica as determined using the BRUNAUER-EMMET-TELLER method described in The Journal of the American Chemical Society, Volume 60, page 309, February 1938, and corresponding to International Standard ISO 5794/1 (Annex D).

The BET specific surface area of a silica used according to the invention preferably remains less than or equal to 100 m²/g, for example less than or equal to 90 m²/g, for example less than or equal to 80 m²/g; this provides a particularly marked improvement in impact resistance.

Moreover, it is often stipulated that this specific surface area is at least equal to 20 m²/g, advantageously at least equal to 40 m²/g and more advantageously still at least equal to 60 m²/g. Specific surface areas of this type provide, in particular, beneficial results in terms of improvement in rigidity.

Thus, the BET specific surface area of a silica according to the invention may advantageously be between 20 and 100 m²/g, more preferably between 40 and 90 m²/g, this BET specific surface area typically being approximately 60 to 80 m²/g.

Moreover, the silica used in accordance with the invention generally has a CTAB specific surface area less than or equal to 130 m²/g, typically between 20 and 100 m²/g, for example between 40 and 90 m²/g, in particular between 50 and 80 m²/g. The “CTAB specific surface area” referred to in the present document designates the external surface area determined in accordance with Standard NF T 45007 (November 1987) (5.12).

The silicas which may be used in accordance with the invention usually have a total pore volume of at least 1.6 cm³/g, this pore volume being generally at least 1.8 cm³/g. The term “total pore volume”, as used in the present description, refers to the pore volume determined using mercury porosity, basically reflecting the porosity of pores having a diameter of between 0.001 and 10 microns, the pore diameters being calculated using WASHBURN'S equation with a contact angle theta of 130° and a surface tension gamma of 484 dynes/cm.

Moreover, the silicas which may be used in accordance with the invention preferably have a filling density when crushed (FDC) which is greater than or equal to 0.1, preferably greater than or equal to 0.15 and more preferably greater than or equal to 0.2, for example greater than or equal to 0.25, wherein this FDC may in some cases be greater than or equal to 0.32. The term “FDC” denotes in the present document density as measured in accordance with Standard NFT 30-042.

Moreover, a silica which may be used in accordance with the invention advantageously has a DOP oil absorption rate of at most 270 ml/100 grams, this oil absorption rate being preferably less than or equal to 260 ml/100 grams and typically less than or equal to 250 ml/100 g. The DOP oil absorption rate to which the present description refers is determined in accordance with Standard NF T 30-022 (March 1953) using dioctyl phthalate.

The pH of a silica which may be used in accordance with the invention is, for its part, advantageously approximately from 6 to 8, typically between 6.5 and 7.5, for example between 6.8 and 7.2. This pH is, in turn, measured in accordance with Standard ISO 787/9 (pH of a suspension of the silica tested at 5% in water).

The moisture content of a silica used as the filler according to the invention is, moreover, advantageously less than or equal to 10% and more preferably less than 9%. Typically, this moisture content is approximately from 6 to 8%.

As emphasised above in the present description, the silicas of the invention have proven particularly suitable as inorganic fillers for improving the impact resistance of thermoplastic polymeric materials without reducing the rigidity thereof—indeed in some cases even increasing this rigidity—and usually improving, at the same time, the tensile elongation characteristics of the material.

The term “thermoplastic polymeric material”, as used in the present description, refers to a material comprising, as its major constituent, a thermoplastic polymer or a mixture of thermoplastic polymers and behaving overall as a thermoplastic polymer. Thus, a thermoplastic polymeric material in the sense of the present description generally comprises at least 50% by mass of a thermoplastic polymer or of a mixture of thermoplastic polymers, usually at least 75% by mass, for example at least 80% by mass and typically at least 90% or even at least 95% by mass. In addition to this/these thermoplastic polymer(s) and the silica used as the filler, the thermoplastic polymeric material may comprise further ingredients such as additives allowing the polymer to be preserved or used effectively or else additives further improving the impact resistance properties of the material (polymeric fillers or inorganic fillers surface-treated with fatty acids, for example). The silica of the invention may also be used in combination with other inorganic fillers such as talc, wollastonite, kaolin, mica, calcium carbonate, fibre glass and/or silicates. The presence of these additional agents may, however, further improve the impact resistance and/or improve other characteristics of the material. Especially, the use of the silica of the invention in conjunction with other inorganic fillers often proves advantageous for improving the scratch resistance of the material.

Nevertheless, the presence of additional components of this type is in no way essential for obtaining the effect of improving impact resistance in accordance with the invention. According to a particular embodiment, the silica of the invention is used as the sole inorganic filler in the polymeric material.

Moreover, it should be noted that the silica used in accordance with the invention does not necessitate surface treatment with organic molecules such as fatty acids to obtain the impact resistance-improving effect of the invention. Nevertheless, according to a conceivable embodiment, the polymeric material can comprise an additive selected from silanes, fatty acids, phosphonic acids, titanates, polypropylene waxes, polyethylene waxes and/or maleic anhydride grafted polypropylenes, providing, especially, improved compatibility between the silica (and any other inorganic filters present) and the thermoplastic polymers.

The silicas of the invention have especially proven advantageous as inorganic fillers in thermoplastic polymeric materials based on one or more polymers selected from polyolefins, polyesters, poly(arylene) oxides, vinyl polychlorides, vinylidene polychloride, vinyl polyacetate, mixtures of these polymers and copolymers based on these polymers.

In particular, the silicas of the invention are particularly suitable for improving the impact resistance of thermoplastic polymeric materials based on one or more polyolefins and, in particular, polymeric materials comprising:
a homopolyolefin selected from a polyethylene, a polypropylene, a polybutylene or a poly(methylpentene);
a copolymeric polyolefin based on at least two types of units selected from ethylene, propylene, butylene and methylpentene units; or
a mixture of two or more of said homopolyolefins and/or said copolymeric polyolefins.

The silicas of the invention are, for example, highly suitable as a filler in thermoplastic materials based on polypropylene, polyethylene or based on mixtures of these polymers or the copolymers thereof. According to an especially beneficial embodiment, the thermoplastic polymeric material incorporating the silica filler according to the invention is a material based on polypropylene or on a copolymer of propylene and ethylene.

Whatever the nature of the thermoplastic material, the silica used as the filler according to the invention is generally at a content of between 0.5% and 10% by mass, for example between 1 and 7% and typically between 2 and 6% relative to the total mass of the thermoplastic polymeric material including the silica.

The silica may be incorporated into the material using any means known per se for the incorporation of inorganic fillers into a thermoplastic polymeric matrix. Generally, the silica is incorporated by mixing under stress the silica and the polymer(s) of the material beyond their glass transition temperature, optionally in the presence of additives, for example heat stabilisers of the type IRGANOX®B225 sold by Ciba. It is generally expedient to produce a mixture under stress in conditions allowing effective incorporation of the silica. A mixture of this type may, for example, be produced using internal or extruder mixer-type devices.

According to a specific aspect, the invention relates to thermoplastic polymeric materials comprising a silica according to the invention as an inorganic filler improving impact resistance.

These materials are particularly suitable for the production of coating layers, mechanical parts and car parts.

More specifically, the invention also relates to thermoplastic polymeric materials of this type comprising one or more polyolefins as the major constituent (i.e. a constituent forming more than 50% by mass, generally at least 75% by mass, for example at least 90% or even 95% by mass of the material) and, more specifically, to materials of this type comprising polypropylene as the major constituent. In these materials, the introduction of the silica of the invention as an inorganic filler usually provides polymeric materials having visual properties similar to the non-filled material, in contrast to that which is observed in most inorganic fillers which modify the hue of the material, its transparency or its light diffusion properties. The preservation of visual properties of the starting material is often such that the introduction of the silica into the material does not modify the appearance of the material visually. The modification of the properties of the material may also be quantified more precisely, for example by spectro-colorimetry, which usually reveals that the introduction of a silica according to the invention into a polymeric material based on a polyolefin such as polyethylene leads at most to very slight modifications of the transparency, light transmission and colouring properties of the material.

These properties especially provide thermoplastic polyolefinic materials which are impact-resistant and have good transparency properties forming a particular aspect of the invention.

Various aspects and advantages of the invention will further emerge from the illustrative and non-limiting examples of the invention which are provided hereinafter.

### EXAMPLE 1

### Preparation of a Precipitated Silica which Useful According to the Invention (Silica S)

1.1. Preparation of a Precipitated Silica Dispersion from Sodium Silicate and an Acidifying Agent (Sulphuric Acid)

The silicate used in this example is a sodium silicate having an SiO₂/Na₂O ratio by weight equal to 3.42 and used in the form of an aqueous solution (s_{silicate}) having a density of 1,230 at 20° C.

The acidifying agent used is an aqueous solution (s_{acid}) of sulphuric acid having a density equal to 1.050 at 20° C.

The reaction for the precipitation of silica from these two solutions was carried out over a total duration of 75 minutes under the following conditions:
1.1.1. Formation of a Starter Comprising a Portion of the Silicate and an Electrolyte (Na₂SO₄)
Into a stainless steel reactor equipped with a propeller stirring system and heating means, the following were introduced, while stirring:
   636 litres of industrial water,
   13.2 kg of Na₂SO₄,
   330 litres of the sodium silicate solution (s_{silicate})
The SiO₂ concentration in the starter thus formed is 80 g/L.
1.1.2. Addition of a First Portion of the Acidifying Agent
The previously prepared starter was brought to a temperature of 95° C. while stirring the mixture continuously.
Once this temperature had been reached, 416 litres of the sulphuric acid solution (S_{acid}) was introduced into the medium, providing in the reaction medium a pH equal to 8 (measured at 95° C.).
1.1.3. Joint Addition of the Second Portion of the Silicate and Another Portion of the Acidifying Agent
Once the aforementioned pH of 8 had been achieved, the following was introduced simultaneously into the medium:
   82 litres of the sodium silicate solution (s_{silicate}); and
   125 litres of the sulphuric acid solution (s_{acid}).
The silicate and the acidifying agent were added jointly in this way while stirring the medium continuously and monitoring the flow rates of the solutions introduced so as to keep the pH of the medium equal to 8+/−0.1 throughout the simultaneous introduction period. More specifically, the joint addition was carried out by introducing the solution (s_{silicate}) at a constant flow rate and by adapting the rate of introduction of the sulphuric acid as a function of the measured pH.
1.1.4. Addition of a Last Portion of Acidifying Agent
Once the joint addition of the silicate and the acidifying agent had been completed, more acidifying agent was introduced into the medium in a proportion of 50 litres of solution (s_{acid}) introduced at a flow rate of 500 L/h (for 6 minutes) while stirring.
This last introduction of acidifying agent brings the pH of the medium to a value of 5.2.
The reaction medium obtained is then in the form of a reaction slurry which has been stirred continuously for 5 minutes.

At the end of these various steps, there is obtained a precipitated silica slurry which has been filtered and washed with water over a filter press so that there is finally recovered a filter cake having a melting loss of 79%.

The silica cake obtained has been fluidified using a mechanical and chemical action, i.e. by subjecting it to mechanical stirring and by adding sodium aluminate to the cake.

At the end of this cleaving operation, there is obtained a silica D dispersion (cleaved cake having low viscosity, pumpable), having a pH equal to 6.4.

1.2. Spray Drying of the Silica D Dispersion

The dispersion obtained at the end of the preceding cleavage was spray dried using a nozzle sprayer.

There was thus obtained a silica S having the following characteristics:
BET specific surface area: 73 m²/g
CTAB specific surface area: 70 m²/g
DOP oil absorption rate: 247 ml/100 g
FDC: 0.29
pH: 6.9
Moisture (2 h at 105° C.) 7%

### EXAMPLE 2

### Use of the Silica S for Improving the Impact Resistance of a Polypropylene-based Thermoplastic Material (Incorporation of the Silica into the Material Using an Internal Mixer)

The silica S from Example 1 was used as an inorganic filler for improving the impact resistance of a polymeric material having the following Formulation (1) (the percentages indicated are percentages by mass relative to the total mass of the formulation):
polypropylene: 96.8%
heat stabiliser: 0.2%
silica S: 3%

The polypropylene used in this example is the polypropylene sold under the name PPH 4060 by Atofina (homopolymeric polypropylene having a melt flow index (230° C. under 2.16 kg) of 3 g/10 min).

The heat stabiliser is, for its part, IRGANOX®B225 sold by Ciba (mixture of antioxidants based on phenolic compounds).

The polymeric material incorporating the silica was prepared by introducing 35 g of polypropylene, 0.07 g of heat stabiliser and 1.1 g of silica S into a Brabender internal mixer initially brought to a temperature of 150° C., with a filling rate of 0.7, wherein the tank of the internal mixer is equipped with two W50-type rotors for thermoplastics, rotating at a speed of 125 revolutions per minute.

The constituents introduced under these conditions were mixed for 5 minutes, wherein the temperature rose during the mixing in view of the internal shearing, leading to a final temperature of approximately 180° C.

A portion of the formulation thus obtained was press moulded in a parallelepiped mould having dimensions of 100 mm×100 mm×10 mm, between two compression plates heated to 200° C. under a pressure of 200 bars (2.10⁻³ Pa) for 2 minutes. The mould was then cooled between the two plates brought to 18° C. under a pressure of 200 bars for 4 minutes.

Two parallelepiped samples having dimensions of 80 mm×4 mm×10 mm were cut from the polymer panel obtained at the end of this moulding process.

On the first sample, the energy at break was measured using the Charpy impact resistance test at 23° C. on the cut sample under the conditions of Standard ISO 179 at 23° C.

On the second sample, the flexural modulus was measured under the conditions of Standard ISO 178 at 23° C.

By way of comparison, the same tests were carried out on samples prepared under the same conditions but from a control formulation (T1) without silica.

The results obtained are set out in Table I (below) which shows that the presence of silica as an inorganic filler in the formulation increases both impact resistance (increase in the energy at break) and rigidity (increase in the flexural modulus).

TABLE I

| | Formulation (1) | Control (T1) |
|---|---|---|
| Polypropylene | 96.8% | 99.8% |
| (PPH 4060) | | |
| Heat stabiliser | 0.2% | 0.2% |
| (IRGANOX ®B225) | | |
| Silica S | 3% | — |
| from Example 1 | | |
| Charpy impact resistance at | 6.3 | 5.1 |
| 23° C. (kJ/m²) | | |
| Flexural modulus | 1.39 | 1.30 |
| (GPa) | | |

### EXAMPLE 3

### Use of the Silica S to Improve the Impact Resistance of a Polypropylene-based Thermoplastic Material (Incorporation of the Silica into the Material Using an Extruder)

The silica S from Example 1 was used as an inorganic filler to improve the impact resistance of a polymeric material having the same overall formulation as that of Example 2 but differing in terms of the manner in which the silica was incorporated.

More specifically, in this example, the polymeric material has the following Formulation (2):
polypropylene PPH 4060: 96.8%
heat stabiliser IRGANOX®B225: 0.2%
silica S from Example 1: 3%

The silica was incorporated into the material by introducing 2,420 g of polypropylene, 5 g of heat stabiliser and 75 g of silica S into a cubical mixer and by mixing for 10 minutes at 150° C., then by introducing the mixture into a WERNER ZSK30 twin-screw extruder (die) with a temperature profile in the extruder of 168° C./168° C./182° C./188° C./182° C., a rotational speed of the co-rotating screws of 230 revolutions per minute and a rate of introduction of the constituents at the input suitable to obtain a torque of 45% of the maximum torque of the extruder.

The rod obtained at the die output was cooled then cut up into granules; the granules obtained were then introduced into an ARBURG injection mould with a temperature profile of 180° C./180° C./180° C./180° C./40° C. and an injection pressure fixed at 55% of the maximum pressure of the machine so as to form a polymer panel from which there were cut two parallelepiped samples having dimensions of 80 mm×4 mm×10 mm, which were used as in the preceding example:
on the first sample, the energy at break was measured using the Charpy impact resistance test at 23° C. on the cut sample under the conditions of Standard ISO 179;
on a second sample, the flexural modulus was measured under the conditions of Standard ISO 178.

Moreover, a dumbbell-shaped sample was also cut out to determine the tensile elongation at break in accordance with Standard ISO 527.

By way of comparison, the same tests were carried out on samples prepared under the same conditions but from a control formulation (T2) without silica.

The results obtained are set out in Table II (below) which shows that, in this case too, the incorporation of silica into the polymeric material causes both an increase in impact resistance and rigidity and also an increase in tensile elongation at break.

TABLE II

| | Formulation (1) | Control (T2) |
|---|---|---|
| Polypropylene | 96.8% | 99.8% |
| (PPH 4060) | | |
| Heat stabiliser | 0.2% | 0.2% |
| (IRGANOX ®B225) | | |
| Silica S | 3% | — |
| from Example 1 | | |
| Charpy impact resistance at | 3.9 | 3.3 |
| 23° C. (kJ/m²) | | |
| Flexural modulus | 1.48 | 1.36 |
| (GPa) | | |
| Tensile elongation at break | 2.1 | 0.7 |
| (%) | | |

This example also compared the visual properties of the two materials using a MINOLTA CM508 spectro-colorimeter. The results obtained are set out in Comparative Table IIA (below) which shows that the two materials have similar visual qualities.

TABLE IIA

| Visual properties | L* | a* | b* | Contrast |
|---|---|---|---|---|
| Formulation (2) | 64 | −0.1 | 4.2 | 15 |
| Control (T2) | 68 | 0.7 | 8.6 | 28 |

L*: luminance on a black background
a*: colorimetric index (red-green axis)
b*: colorimetric index (yellow-blue axis)
Contrast: black background/white background contrast; reflects the light transmission properties

### EXAMPLE 4

### Use of the Silica S to Improve the Impact Resistance of a Thermoplastic Material Based on a Polyolefinic Copolymer (Incorporation of the Silica into the Material Using an Internal Mixer)

The silica S from Example 1 was used as an inorganic filler to improve the impact resistance of a polymeric material having the following Formulation (3) (the percentages indicated are percentages by mass relative to the total mass of the formulation):
polyolefinic copolymer: 96.8%
heat stabiliser: 0.2%
silica S: 3%

The polyolefinic copolymer used in this example is a copolymer of propylene and heterophasic ethylene sold under the name PPC 7712 by Atofina (copolymer having a melt flow index (230° C. under 2.16 kg) of 13 g/10 min).

The heat stabiliser is the IRGANOX®B225 from Examples 2 and 3.

The polymeric material incorporating the silica was prepared by introducing 35 g of polypropylene, 0.07 g of heat stabiliser and 1.1 g of silica S into a Brabender internal mixer under the conditions of Example 2; the composition produced was then press moulded and two parallelepiped samples having dimensions of 80 mm×4 mm×10 mm were cut out in the same manner as in Example 2.

On the first sample, the energy at break was measured using the Charpy impact resistance test at 23° C. on the cut sample under the conditions of Standard 179. On the second sample, the flexural modulus was measured under the conditions of Standard ISO 178.

By way of comparison, the same tests were carried out on samples prepared under the same conditions but from a control formulation (T3) without silica.

The results set out in Table III (below) show that the presence of silica as an inorganic filler in the formulation increases impact resistance and also (to a lesser degree) rigidity.

TABLE III

| | Formulation (1) | Control (T3) |
|---|---|---|
| Copolymer | 96.8% | 99.8% |
| (PPC 7712) | | |
| Heat stabiliser | 0.2% | 0.2% |
| (IRGANOX ®B225) | | |
| Silica S | 3% | — |
| from Example 1 | | |
| Charpy impact resistance at | 6.3 | 5.1 |
| 23° C. (kJ/m²) | | |
| Flexural modulus | 1.39 | 1.30 |
| (GPa) | | |

1-16. (canceled)

17. A method for increasing the impact resistance of a thermoplastic polymeric material, comprising employing a silica as an inorganic filler in said thermoplastic polymeric material, wherein said silica has a BET specific surface area less than or equal to 130 m²/g and is obtainable by drying an aqueous silica dispersion produced from a process for the precipitation of silica by reacting a silicate and an acidifying agent, wherein the precipitation process includes the following steps:
(A) forming a starter containing in aqueous medium:
at least a portion of the total amount of silicate involved in the precipitation reaction; and
an electrolyte;
(B) adding a first portion of acidifying agent to the starter from step (A) until a pH of between 7 and 8.5 is obtained; and
(C) when a portion only of the involved silicate is implemented in step (A), adding to the reaction medium obtained from step (B) the remaining amount of silicate in conjunction with another portion of the acidifying agent.

18. The method of claim 17, wherein the silica employed is obtainable by drying an aqueous silica dispersion produced from a process for the precipitation of silica by reacting a silicate and an acidifying agent, wherein the precipitation process includes the following steps:
(A) forming a starter containing in aqueous medium:
a portion only of the total amount of silicate involved in the reaction; and
an electrolyte;
(B) adding a first portion of acidifying agent to the starter from step (A) until a pH of between 7 and 8.5 is obtained;
(C) adding to the reaction medium obtained from step (B) the second portion of the silicate while jointly introducing another portion of the acidifying agent, while maintaining the pH of the medium substantially constant during this joint addition.

19. The method of claim 17, wherein the silica employed is a silica in the form of substantially spherical balls, which is obtainable by spray drying an aqueous silica dispersion, wherein said aqueous silica dispersion:
is produced from a process for the precipitation of silica by reacting a silicate and an acidifying agent, including the successive steps (A) to (C) as defined in claim 17,
has a dry matter content of at least 18% by mass;
has a pH of at least 4.

20. The method of claim 17, wherein the silica employed is obtainable by carrying out the following steps:
(A) forming a starter containing in aqueous medium:
sodium silicate or another silicate; and
an electrolyte;
(B) adding an acidifying agent to the starter from step (A) until a pH of between 7.5 and 8.5 is obtained;
(C) adding a silicate to the reaction medium obtained from step (B) while jointly introducing an acidifying agent and while maintaining the pH of the medium substantially constant in the pH range of between 7.5 and 8.5 during this joint addition;
(D) adding an acidifying agent to the reaction medium obtained from step (C) until a pH of between 4 and 7 is obtained;
(E) filtering the dispersion obtained from step (D), then mechanically disintegrating the filter cake obtained; and
(F) spray drying the cleaved cake obtained from step (E).

21. The method of claim 20, wherein the filter cake is disintegrated in step (E) in the presence of sodium aluminate as the disintegrating agent.

22. The method of claim 17, wherein the silica employed has a BET specific surface area of between 20 and 100 m²/g and preferably between 40 and 90 m²/g.

23. The method of claim 17, wherein the silica employed has a total pore volume of at least 1.6 cm³/g.

24. The method of claim 17, wherein the silica employed has a filling density when compacted (FDC) of greater than or equal to 0.1.

25. The method of claim 17, wherein the silica employed has a DOP oil absorption rate of at most 270 ml/100 grams.

26. The method of claim 17, wherein the silica is employed as the sole inorganic filler in the thermoplastic polymeric material.

27. The method of claim 17, wherein the thermoplastic polymeric material is based on one or more polymers selected from the group consisting of polyolefins, polyesters, poly(arylene) oxides, vinyl polychlorides, vinylidene polychloride, vinyl polyacetate, mixtures of these polymers, and copolymers based on these polymers.

28. The method of claim 17, wherein the thermoplastic polymeric material is based on one or more polyolefins.

29. The method of claim 28, wherein the thermoplastic polymeric material comprises:
a homopolyolefin selected from the group consisting of polyethylene, a polypropylene, a polybutylene and a poly(methylpentene);
a copolymeric polyolefin based on at least two types of units selected from the group consisting of ethylene, propylene, butylene and methylpentene units; or
a mixture of two or more of said homopolyolefins and/or said copolymeric polyolefins.

30. The method of claim 29, wherein the thermoplastic polymeric material is based on polypropylene or on a copolymer of propylene and ethylene.

31. The method of claim 17, wherein the silica is introduced into the thermoplastic polymeric material at a content of between 0.5% and 10% by mass relative to the total mass of the thermoplastic polymeric material including the silica.

32. A thermoplastic polymeric material comprising a silica as defined in claim 17, as an inorganic filler improving impact resistance, wherein said silica has a BET specific surface area less than or equal to 130 m²/g and is obtainable by drying an aqueous silica dispersion produced from a process for the precipitation of silica by reacting a silicate and an acidifying agent, wherein the precipitation process includes the following steps:
(A) forming a starter containing in aqueous medium:
at least a portion of the total amount of silicate involved in the precipitation reaction; and
an electrolyte;
(B) adding a first portion of acidifying agent to the starter from step (A) until a pH of between 7 and 8.5 is obtained; and
(C) when a portion only of the involved silicate is implemented in step (A), adding to the reaction medium obtained from step (B) the remaining amount of silicate in conjunction with another portion of the acidifying agent.

33. The thermoplastic polymeric material according to claim 32, which comprises one or more polyolefins as the major constituent.
